(19) United States
(12) Patent Application Publication
(10) Pub. No.: US 2009/0233674 A1
(43) Pub. Date: Sep. 17, 2009

(54) GAMING SYSTEM AND A METHOD OF GAMING

(75) Inventor: Hyong Joo Kim, Meadowbank (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, North Ryde (AU)

(21) Appl. No.: 12/371,352

(22) Filed: Feb. 13, 2009

(30) Foreign Application Priority Data
Feb. 15, 2008 (AU) 2008900738

(51) Int. Cl. A63F 9/24; A63F 13/00

(52) U.S. Cl. 463/16; 463/30; 463/29

(57) ABSTRACT

A gaming system is disclosed which includes a plurality of game portions, a plurality of game panels, each game portion being associated with at least one game panel, and a selector arranged to select at least one game portion and at least one game panel. The gaming system is arranged to communicate to a player the selected at least one game portion and the selected at least one game panel, and a winning game outcome is determined by a combination of at least one selected game portion and at least one game panel associated with the at least one selected game portion. A corresponding method is also disclosed.

### CROSS-REFERENCE TO RELATED APPLICATIONS

The present application claims the benefit of priority to Australian Provisional Patent Application No. 2008900738, filed on Feb. 15, 2008, entitled “A GAMING SYSTEM AND A METHOD OF GAMING”, which is herein incorporated by reference in its entirety.

### FIELD OF THE INVENTION

The present invention relates to a gaming system and to a method of gaming.

### BACKGROUND OF THE INVENTION

It is known to provide a gaming system which comprises at least one wheel provided with a plurality of identifiers equidistantly disposed around the wheel. The wheel is rotatable and game outcomes are determined using a pointer disposed adjacent the periphery of the wheel.

However, while such gaming systems provide users with enjoyment, a need exists for alternative gaming systems in order to maintain or increase player enjoyment.

### SUMMARY OF THE INVENTION

In accordance with a first aspect of the present invention, there is provided a gaming system including:

a plurality of game portions;

a plurality of game panels, each game portion being associated with at least one game panel; and

a selector arranged to select at least one game portion and at least one game panel;

the gaming system being arranged to communicate to a player the selected at least one game portion and the selected at least one game panel;

wherein a winning game outcome is determined by a combination of at least one selected game portion and at least one game panel associated with the at least one selected game portion.

In one embodiment each game portion has an associated identifier which may include a symbol, number, icon or picture, or are in the form of a particular colour.

In one embodiment, the gaming system includes physical game portions and game panels.

In an alternative embodiment, the gaming system is implemented electronically such that the game portions and the game panels are represented graphically on a video display.

The gaming system may further include a display controller arranged to cause selected game portions and selected game panels to be emphasised relative to game portions and game panels which have not been selected.

In an embodiment wherein the gaming system includes physical game portions and game panels, the gaming system may include a plurality of light devices, each light device being associated with one of the game portions and game panels, and the light devices being controllable by the display controller so as to illuminate the selected game portions and game panels. The light devices may be LEDs.

In one embodiment, the display controller may be arranged so as to illuminate the selected game portions and/or game panels with an intensity greater than game portions and game panels which have not been selected.

In one embodiment, the display controller may be arranged so as to illuminate the selected game portions and/or game panels with a different colour than game portions and game panels which have not been selected.

In one embodiment, the display controller may be arranged so as to cause the selected game portions and/or game panels to flash.

In one embodiment, the game portions and the game panels together define a disk-like configuration having an inner disk and an annular portion surrounding the inner disk, the game portions are segments of the inner disk, and the game panels are disposed in the annular portion.

In one embodiment, the gaming system includes more game panels than game portions.

Each game portion may be associated with 5 game panels.

In one embodiment, the gaming system includes an outcome evaluator arranged to determine whether a winning outcome exists on the basis of the game portions and game panels selected by the selector.

In one embodiment, the gaming system is arranged such that selection of a game portion effects selection of an identifier associated with the game portion to form part of a game outcome, and selection of at least one game panel signifies how many identifiers are in the game outcome.

The gaming system may be arranged such that a winning outcome is determined by comparing an outcome combination including a game portion and at least one associated game panel with a pay table.

In one embodiment, one or more of the selector and the outcome evaluator is constituted, at least in part, by a processor executing program code stored in a memory.

In one embodiment, the gaming system includes a game play mechanism operable to place a wager and the outcome evaluator evaluates the outcome based on the wager and based on the game portions and game panels selected by the selector.

In accordance with a second aspect of the present invention, there is provided a method of gaming, the method including:

providing a plurality of game portions;

providing a plurality of game panels, each game portion being associated with at least one game panel;

selecting at least one game portion and at least one game panel;

communicating to a player the selected at least one game portion and the selected at least one game panel;

determining a winning game outcome by evaluating a combination of at least one selected game portion and at least one game panel associated with the at least one selected game portion.

In accordance with a third aspect of the present invention, there is provided a computer program arranged when loaded into a computer to instruct the computer to operate in accordance with a gaming system including:

a plurality of game portions;

a plurality of game panels, each game portion being associated with at least one game panel; and

a selector arranged to select at least one game portion and at least one game panel;

the gaming system being arranged to communicate to a player the selected at least one game portion and the selected at least one game panel;

wherein a winning game outcome is determined by a combination of at least one selected game portion and at least one game panel associated with the at least one selected game portion.

In accordance with a fourth aspect of the present invention, there is provided a computer readable medium having computer readable program code embodied therein, the computer readable program code being arranged when loaded into a computer to cause the computer to operate in accordance with a gaming system including:

a plurality of game portions;

a plurality of game panels, each game portion being associated with at least one game panel; and

a selector arranged to select at least one game portion and at least one game panel;

the gaming system being arranged to communicate to a player the selected at least one game portion and the selected at least one game panel;

wherein a winning game outcome is determined by a combination of at least one selected game portion and at least one game panel associated with the at least one selected game portion.

### BRIEF DESCRIPTION OF THE DRAWINGS

Certain embodiments of the present invention will now be described, by way of example only, with reference to the accompanying drawings, in which:

FIG. 1 is a diagrammatic representation of a gaming system in accordance with an embodiment of the present invention;

FIG. 2 is a schematic diagram of a game controller of the gaming system shown in FIG. 1;

FIG. 3 is a schematic block diagram of a gaming system in accordance with an alternative embodiment of the present invention;

FIG. 4 is a schematic block diagram illustrating operative components of the gaming system shown in FIG. 3;

FIG. 5 is a diagrammatic representation of a gaming system implemented in the form of a gaming machine;

FIG. 6 is a schematic block diagram of operative components of the gaming machine shown in FIG. 5;

FIG. 7 is a schematic block diagram of components of a memory of the gaming machine shown in FIG. 5;

FIG. 8 is a schematic diagram of a gaming system in accordance with an alternative embodiment of the present invention;

FIG. 9 is a flow diagram illustrating operation of a gaming system in accordance with an embodiment of the present invention during use; and

FIG. 10 is a diagrammatic representation of the gaming system shown in FIG. 1 during use.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DESCRIPTION OF AN EMBODIMENT OF THE INVENTION

Referring to the drawings, there is shown a gaming system 10 arranged to implement a probabilistic game.

The gaming system 10 includes a plurality of game portions 12 and a plurality of game panels 14 disposed around the game portions 12 such that each game portion 12 is disposed adjacent several game panels 14, in this example 5 game panels 14.

Each game portion 12 has an associated identifier 16 which may be in the form of a symbol such as a number, icon, picture and so on, or may be in the form of a particular colour.

Operation of the gaming system 10 is such that game portions 12 and game panels 14 are selected randomly and a game outcome is determined on the basis of the selected game portions 12 and the selected game panels 14.

In one embodiment, during implementation of a game one or more identifiers 16 are selected by selecting one or more game portions 12, one or more game panels 14 are selected, and a potentially winning outcome is obtained when a game portion 12 and at least one game panel 14 located adjacent the game portion 12 are selected.

The prize associated with the outcome may increase if multiple game panels 14 are selected adjacent a selected game portion 12.

In one embodiment, the game portions 12 are usable to facilitate selection of an identifier 16 and the game panels 14 are used to signify how many identifiers 16 are considered to be present in the game outcome. For example, if a game portion 12 having an identifier 16 in the form of an Ace symbol is selected and three game panels 16 adjacent the selected game portion 12 are selected, the game outcome may be deemed to be a winning outcome including 3× Aces.

In this embodiment, in order for a player to clearly see which portions have been selected, the selected game portions 12 are illuminated, for example by disposing an LED under each game portion 12 and illuminating the LEDs associated with selected game portions 12. Similarly, in this embodiment the selected game panels 14 are also illuminated, for example by disposing an LED under each game panel 14 and illuminating the LEDs associated with selected game panels 14.

It will be understood that each game portion 12 and adjacent game panels 14 together define an outcome, in this example the game portion 12 defining the identifier in the outcome and the game panels 14 defining the number of identifiers in the outcome.

A winning outcome may be defined on the basis of any pattern or sequence defined by each game portion/game panel combination and prizes awarded based on the game portion/game panel combination. For example, during use bets may be received from players in respect of particular identifiers 16, and a prize obtained when a bet is placed in respect of an identifier, and the identifier 16 and a required number of associated game panels 14 corresponding to a winning outcome are selected. Alternatively, a player may place a bet not particular to any identifier 16 and receive an award when any selected game portions 12 and game panels 14 correspond to a winning outcome.

In an example, if a winning outcome exists, a player is awarded a win amount based on the bet amount and a win multiplier associated with the winning outcome. The win multipliers may be derived from a pay table including details of all possible winning outcomes and win multipliers associated with the winning outcomes.

In the present example, the gaming system is of generally disk-like configuration, each of the game portions 14 corresponds to a segment of an inner disk, and the game panels 14 together define an annular portion which surrounds the inner disk.

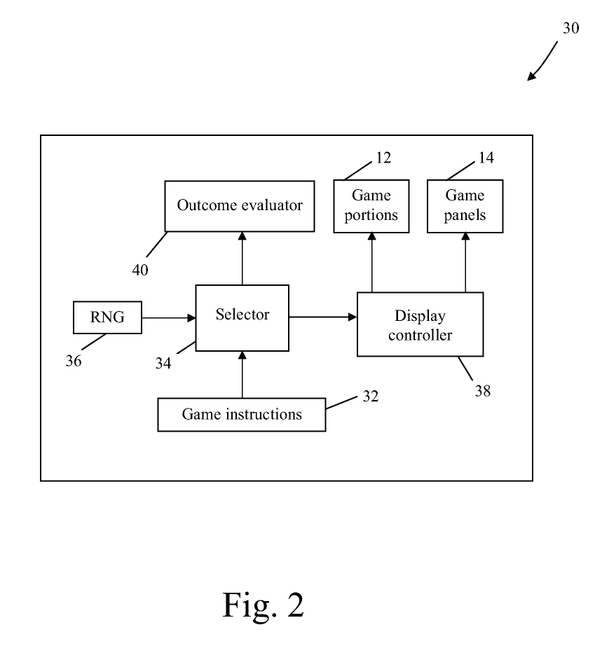

A game controller 30 for controlling operation of the gaming system 10 is shown diagrammatically in FIG. 2.

The game controller 30 includes a memory 32 arranged to store game instructions and any other data to operate the gaming system to implement a game, a selector 34 arranged to select at least one game portion 12 and at least one game panel 14 using a random number generator 36, a display controller 38 arranged to communicate with light devices associated with the game portions 12 and game panels 14 so as to cause the or each selected game portion 12 and the or each selected game panel 14 to illuminate relative to game portions and game panels which have not been selected. In this example, the light devices include LEDs, although it will be appreciated that other light devices may be used.

It will also be appreciated that instead of providing light devices associated with each of the game portions and game panels in order to indicate the selected game portions and gams panels to a player, the gaming system may include at least one actuator arranged to cause selected game portions and game panels to move relative to game portions and game panels which have not been selected, for example so as to raise relative to game portions and game panels which have not been selected.

It will be appreciated that the random number generator 36 may be of a type which is arranged to generate pseudo random numbers based on a seed number, and that in this specification the term “random” will be understood accordingly to mean truly random or pseudo random.

The game controller 30 also includes an outcome evaluator 40 which in accordance with the game instructions 32 determines game outcomes based on the selected game portions 12 and the selected game panels 14.

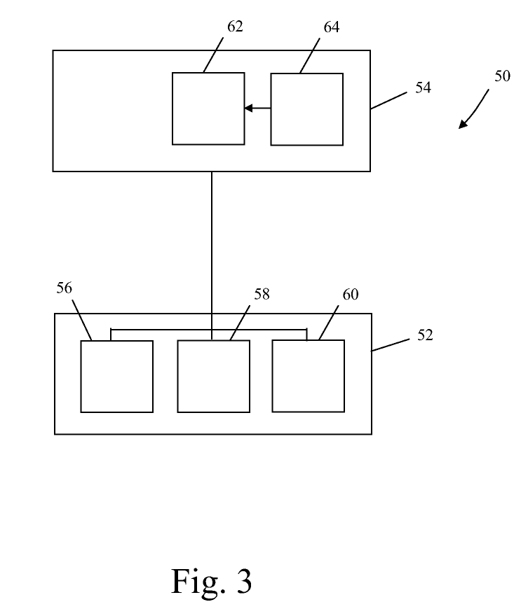

An alternative gaming system 50 implemented using an electronic gaming machine is shown schematically in FIG. 3.

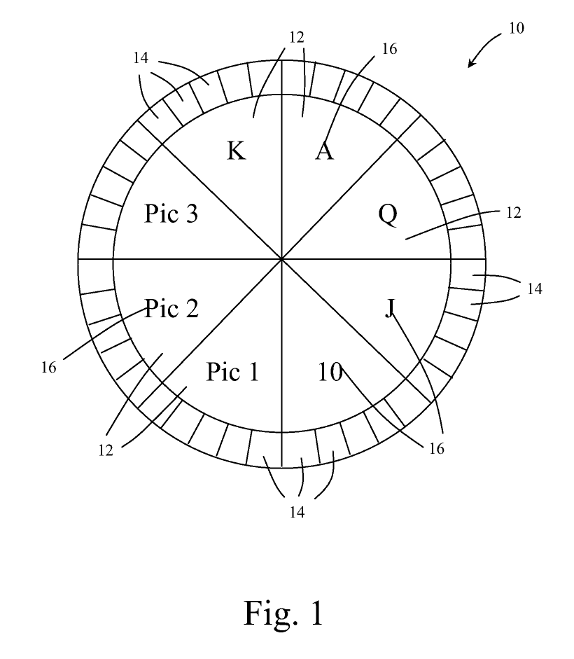

Operation is similar to the embodiment shown in FIGS. 1 and 2 with the difference being that a video representation of the game portions 12 and game panels 14 is shown on an electronic gaming machine. For the purpose of describing this embodiment, like and similar features to features described in relation to FIGS. 1 and 2 are indicated with like reference numerals.

Operation of the present embodiment is such that several game portions 12 and game panels 14 are selected, the selected game portions 12 and game panels 14 are emphasised on a video display relative to game portions 12 and game panels 14 which have not been selected, and game outcomes are determined based on the selected emphasised game portions 12 and panel portions 14.

The core components include a player interface 52 and a game controller 54. The player interface 52 is arranged to enable interaction between a player and the gaming system and for this purpose includes input/output components for the player to enter instructions and play the game.

Components of the player interface 52 may vary but will typically include a credit mechanism 56 to enable a player to input credits and receive payouts, one or more displays 58 which may include a touch screen, and a game play mechanism 60 arranged to enable a player to input game play instructions.

The game controller 54 is in data communication with the player interface 52 and typically includes a processor 62 arranged to process game play instructions and output game player outcomes to the display 58. Typically, the game play instructions are stored as program code in a memory 64 that can also be hardwired. It will be understood that in this specification the term “processor” is used to refer generically to any device that can process game play instructions and may include a microprocessor, microcontroller, programmable logic device or other computational device such as a personal computer or a server.

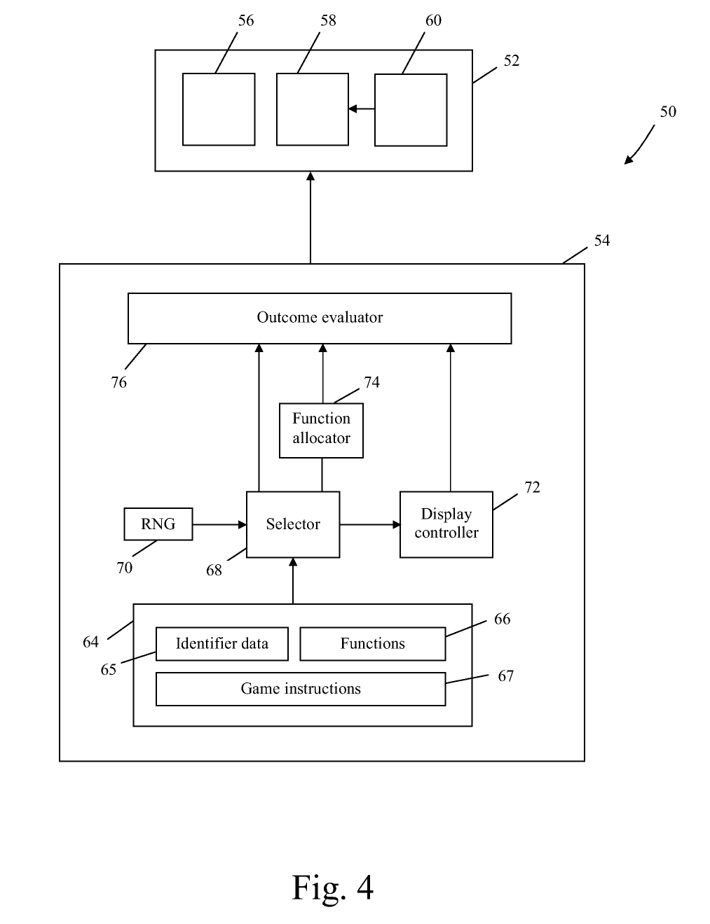

A functional diagram illustrating operative components of the game controller 54 is shown in FIG. 4.

The memory 64 is arranged to store identifier data 65 indicative of identifiers associated with the game portions 12 such as symbols associated with the portions and/or colours associated with the game portions 12, function data 66 indicative of one or more functions allocatable to the identifiers if any, and game instruction data 67 indicative of game instructions usable by the gaming machine 50 to control operation of the game.

The game controller 54 includes a selector 68 which is arranged to select several game portions 12 for display to a player as emphasised game portions 12 and to select several game panels 14 for display to a player as emphasised game panels 14. In this example, the selection carried out by the selector 68 is made using a random number generator 70.

It will be appreciated that the random number generator 70 may be of a type which is arranged to generate pseudo random numbers based on a seed number, and that in this specification the term “random” will be understood accordingly to mean truly random or pseudo random.

The game controller 54 also includes a display controller 72 arranged to modify the display so as to provide the appearance on a graphical display of the gaming machine 50 that selected game portions 12 and selected game panels 14 of the game sections 12 are emphasised relative to portions which have not been selected. In the present example game portions 12 and game panels 14 are emphasised by displaying the selected game portions 12 and game panels 14 with greater intensity than game portions and game panels which have not been selected. However, other variations are possible, such as displaying the selected game portions 12 and game panels 14 in a different colour, causing the selected game portions and game panels to flash, and so on.

In this example, the game controller 54 also includes a function allocator 74 arranged in some embodiments to select and allocate one or more functions to one or more game portion 12. Such functions include a wild function, a scatter function, or any other function which may be applied to the game.

The game controller 54 also includes an outcome evaluator 76 which in accordance with the game instructions 67 determines game outcomes based on the selected game portions 12 and game panels 14.

In the embodiments described below, the selector 68, the function allocator 74, the display controller 72 and the outcome evaluator 76 are at least partly implemented using the processor 62 and associated software, although it will be understood that other implementations are envisaged.

The gaming system 10 can take a number of different forms.

In a first form, a stand alone gaming machine is provided wherein all or most components implementing the game are present in a player operable gaming machine.

In a second form, a distributed architecture is provided wherein some of the components implementing the game are present in a player operable gaming machine and some of the components implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

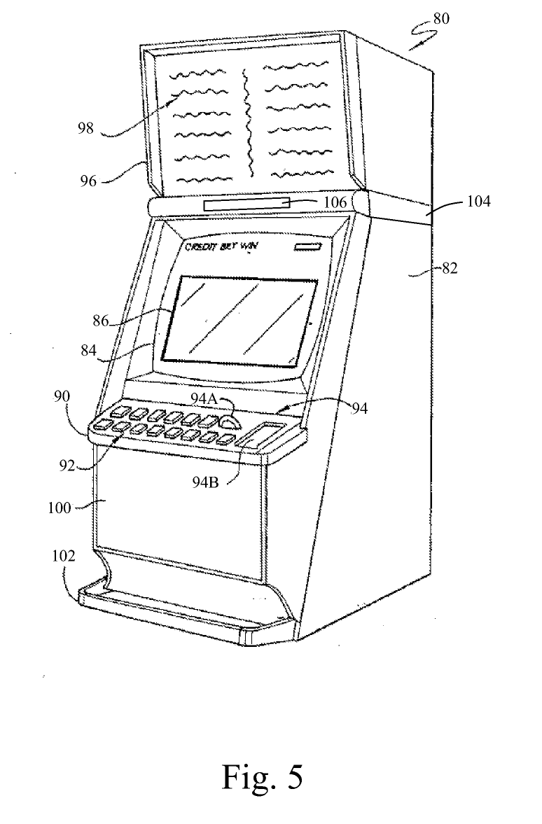

A gaming system in the form of a stand alone gaming machine 80 is illustrated in FIG. 5. The gaming machine 80 includes a console 82 having a display 84 on which is displayed representations of a game 86 that can be played by a player. A mid-trim 90 of the gaming machine 80 houses a bank of buttons 92 for enabling a player to interact with the gaming machine, in particular during gameplay. The mid-trim 90 also houses a credit input mechanism 94 which in this example includes a coin input chute 94A and a bill collector 94B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 96 may carry artwork 98, including for example pay tables and details of bonus awards and other information or images relating to the game. Further artwork and/or information may be provided on a front panel 100 of the console 82. A coin tray 102 is mounted beneath the front panel 100 for dispensing cash payouts from the gaming machine 80.

The display 84 is in the form of a video display unit, particularly a cathode ray tube screen device. Alternatively, the display 84 may be a liquid crystal display, plasma screen, or any other suitable video display unit. The top box 96 may also include a display, for example a video display unit, which may be of the same type as the display 84, or of a different type. The display 84 may include a touch screen usable by a player to interact with the gaming machine, in particular during game play.

The display 84 in this example is arranged to display a representation of the game portions 12 and game panels 14, for example in a disk-like configuration as shown in FIG. 1.

A player marketing module (PMM) 104 having a display 106 is connected to the gaming machine 10. The main purpose of the PMM 104 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

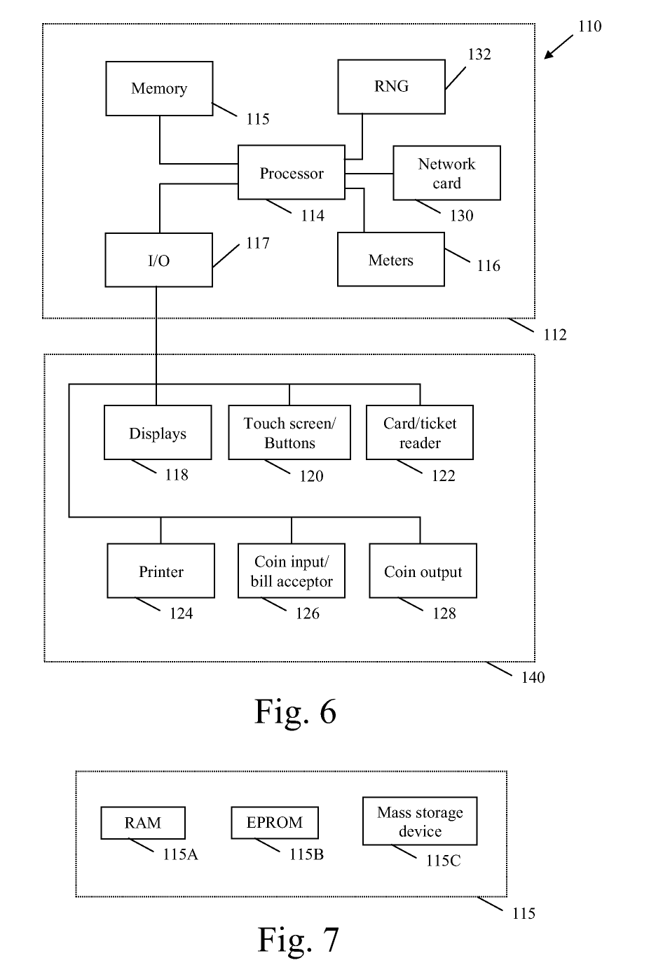

FIG. 6 shows a block diagram of operative components of a gaming machine 110 which may be the same as or different to the gaming machine shown in FIG. 5.

The gaming machine 110 includes a game controller 112 having a processor 114. Instructions and data to control operation of the processor 114 in accordance with the present invention are stored in a memory 115 which is in data communication with the processor 114.

Typically, the gaming machine 110 will include both volatile and non-volatile memory and more than one of each type of memory, with such memories being collectively represented by the memory 115.

FIG. 7 shows a block diagram of the main components of an exemplary memory 115. The memory 115 includes RAM 115A, EPROM 115B and a mass storage device 115C. The RAM 115A typically temporarily holds program files for execution by the processor 114 and related data. The EPROM 115B may be a boot ROM device and/or may contain some system or game related code. The mass storage device 103C is typically used to store game programs, the integrity of which may be verified and/or authenticated by the processor 114 using protected code from the EPROM 115B or elsewhere.

The gaming machine has hardware meters 116 for purposes including ensuring regulatory compliance and monitoring player credit, an input/output (I/O) interface 117 for communicating with a player interface 140 of the gaming machine 110, the player interface 140 having several peripheral devices. The input/output interface 117 and/or the peripheral devices may be intelligent devices with their own memory for storing associated instructions and data for use with the input/output interface or the peripheral devices. A random number generator module 132 generates random numbers for use by the processor 114.

In the example shown in FIG. 6, the peripheral devices that communicate with the game controller 112 include one or more displays 118, a touch screen and/or bank of buttons 120, a card and/or ticket reader 122, a printer 124, a bill acceptor and/or coin input mechanism 126 and a coin output mechanism 128. Additional hardware may be included as part of the gaming machine 110, or hardware may be omitted based on the specific implementation.

In addition, the gaming machine 110 may include a communications interface, for example a network card 130. The network card may, for example, send status information, accounting information or other information to a central controller, server or database and receive data or commands from the central controller, server or database.

It is also possible for the operative components of the gaming machine 110 to be distributed, for example input/output devices 118, 120, 122, 124, 126, 128 may be provided remotely from the game controller 112.

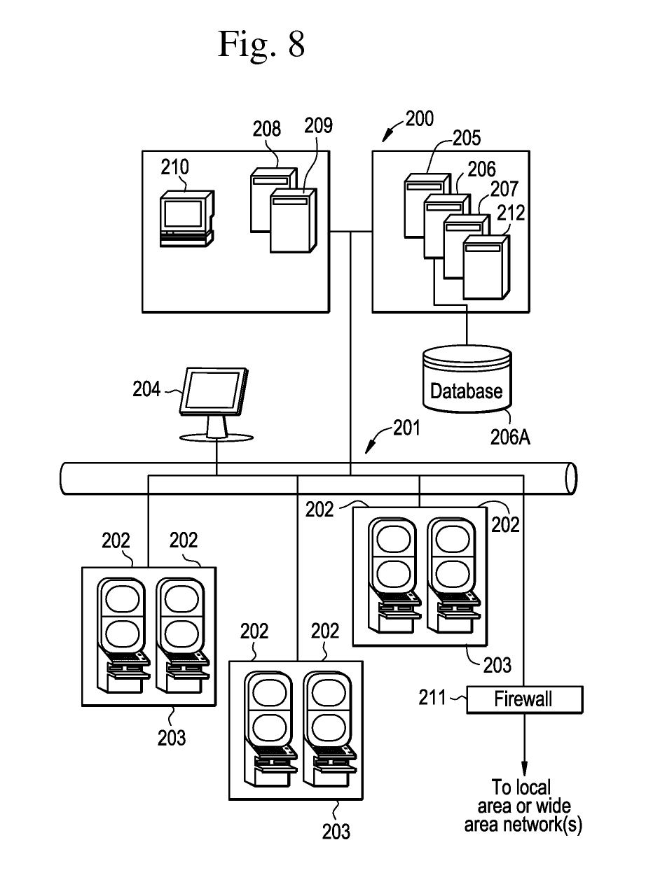

FIG. 8 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 80,110 shown in FIGS. 5 and 6, or may have simplified functionality depending on the rules and/or guidelines for implementing game play. While banks 203 of two gaming machines are illustrated in FIG. 8, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During operation, the game controller, whether implemented in a stand alone gaming machine or over a network, implements a probabilistic game wherein at least during part of the game the gaming system selects one or more game portions 12 and one or more game panels 14, emphasises the selected game portions and game panels relative to game portions and game panels which have not been selected, and determines game outcomes based on the selected game portions 12 and selected game panels 14.

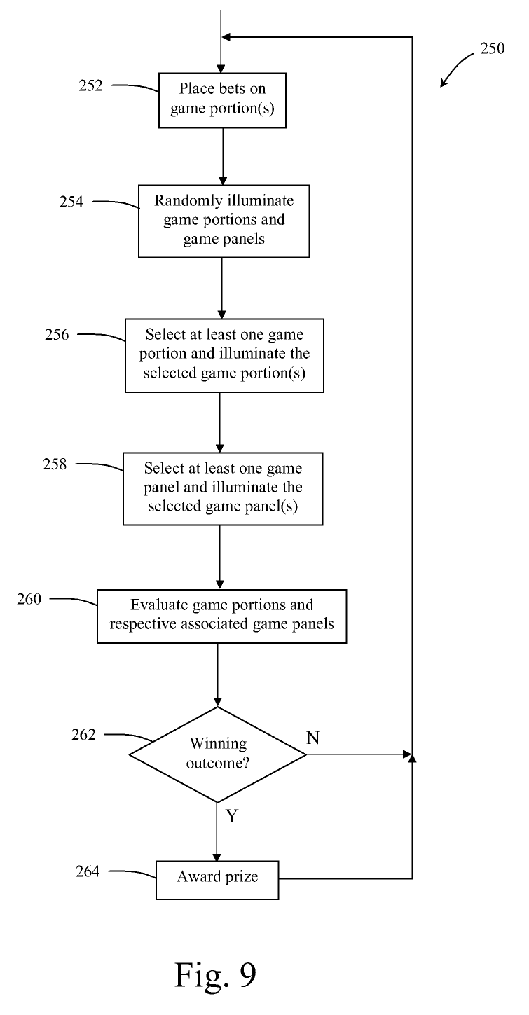

Examples of specific implementations of the gaming system will now be described in relation to flow diagram 250 shown in FIG. 9 which illustrates steps 252 to 264 of a method of gaming implemented by the gaming system according to the embodiment shown in FIG. 1.

However, it will be understood that implementation may also be carried out using other gaming system architectures such as a stand alone electronic gaming machine 50 shown in FIG. 5, or as a network architecture of the type shown in FIG. 8.

In order to take part in the game implemented by the gaming system 10, a player first places a bet, in this example in respect of one or more identifiers 16 chosen by the player. The bets may be placed directly on the relevant game portions so that all players and operators of the gaming system can clearly see the bets placed. After receipt of all bets, a game operator starts the gaming system 10 which causes the display controller 38 to randomly illuminate the game portions 12 and the game panels 14 and thereby create anticipation amongst the players.

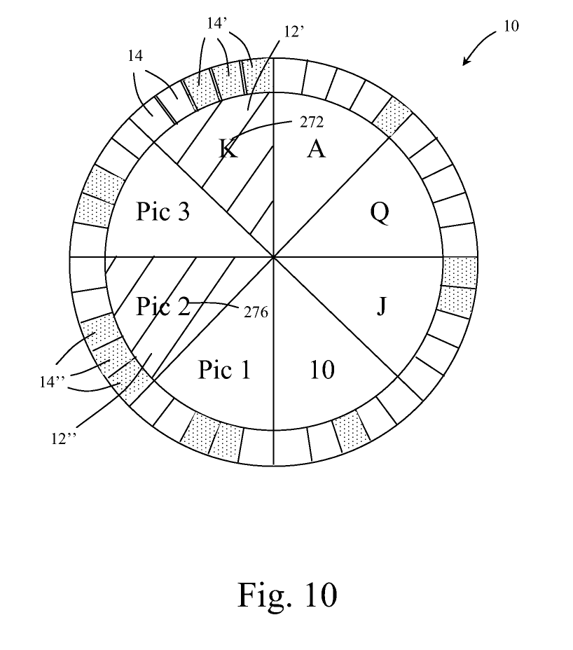

The selector 34 then selects at least one game portion 12 and at least one game panel 14 and the display controller illuminates the selected game portion(s) 12 and game panel(s) 14. In this example, two game portions 12 and 14 game panels 14 are selected, as shown in FIG. 10.

It will be understood that while the number of game portions 12 and game panels 14 is random, the number of game panels 14 selected should be greater than the total number of game portions 12 and less than twice the total number of game portions 12.

As shown in FIG. 10, the game outcome includes a first selected game portion 12′ including an identifier in the form of a King symbol 272 and a second selected game portion 12″ including an identifier in the form of a Pic2 symbol 276. The first selected game portion 12′ is associated with five game panels 14, three of which are selected game panels 14′, and the second game portion 12″ is associated with five game panels, three of which are selected game panels 14″.

In the present example, each selected game portion 12′, 12″ and associated game panels 14′, 14″ together define an outcome such that the game portion defines the identifier 16 and the selected game panels 14′, 14″ define the number of identifiers in the outcome. In the present example, two potentially winning outcomes are defined, a first outcome corresponding to 3 King symbols and a second outcome corresponding to 3 Pic2 symbols.

The selected game portions 12 and game panels 14 are evaluated by the outcome evaluator 40 and a determination is made as to whether the selected game portions 12 and selected game panels 14 correspond to one or more winning outcomes. If any player has placed a bet in respect of one of the identifiers associated with a winning outcome, operators of the gaming system 10 then award a prize to the or each player. The prize may be a monetary amount based on the amount bet and the relevant winning outcome. For example, the prize amount may be calculated by multiplying the bet amount by a win multiplier extracted from a pay table and associated with the winning outcome. In one example, each winning game portion/game panel's combination has an associated win multiplier which may be 5 for a win outcome deemed to be 3 symbols, 10 for a win outcome deemed to be 4 symbols and 30 for a win outcome deemed to be 5 symbols.

In an alternative embodiment wherein a bet is of a form not specific to a particular identifier 16, winning outcomes may be determined by comparing all combinations of selected game portions 12 and associated selected game panels 14 with a pay table.

The game implemented by the gaming system 10 may be played by one player or by multiple players simultaneously.

It is to be understood that, if any prior art is referred to herein, such reference does not constitute an admission that the prior art forms a part of the common general knowledge in the art in any country.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

It will be appreciably persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a plurality of game portions;
a plurality of game panels, each game portion being associated with at least one game panel; and
a selector arranged to select at least one game portion and at least one game panel;
the gaming system being arranged to communicate to a player the selected at least one game portion and the selected at least one game panel;
wherein a winning game outcome is determined by a combination of at least one selected game portion and at least one game panel associated with the at least one selected game portion.

2. A gaming system as claimed in claim 1, wherein the gaming system comprises physical game portions and game panels.

3. A gaming system as claimed in claim 2, comprising a plurality of light devices, each light device being associated with one of the game portions and game panels, and the light devices being controllable by the display controller so as to illuminate the selected game portions and game panels.

4. A gaming system as claimed in claim 3, wherein the light devices are light emitting diodes (LEDs).

5. A gaming system as claimed in claim 1, wherein the gaming system is implemented electronically such that the game portions and the game panels are represented graphically on a video display.

6. A gaming system as claimed in claim 1, wherein each game portion has an associated identifier.

7. A gaming system as claimed in claim 6, wherein the identifier comprises a symbol, number, icon or picture.

8. A gaming system as claimed in claim 6, wherein the identifier is in the form of a particular colour.

9. A gaming system as claimed in claim 1, further comprising a display controller arranged to cause selected game portions and selected game panels to be emphasised relative to game portions and game panels which have not been selected.

10. A gaming system as claimed in claim 9, wherein the display controller is arranged so as to illuminate the selected game portions and/or game panels with an intensity greater than game portions and game panels which have not been selected.

11. A gaming system as claimed in claim 9, wherein the display controller is arranged so as to illuminate the selected game portions and/or game panels with a different colour than game portions and game panels which have not been selected.

12. A gaming system as claimed in claim 9, wherein the display controller is arranged so as to cause the selected game portions and/or game panels to flash.

13. A gaming system as claimed in claim 1, wherein the game portions and the game panels together define a disk-like configuration having an inner disk and an annular portion surrounding the inner disk, the game portions are segments of the inner disk, and the game panels are disposed in the annular portion.

14. A gaming system as claimed in claim 1, wherein the gaming system comprises more game panels than game portions.

15. A gaming system as claimed in claim 14, wherein each game portion is associated with 5 game panels.

16. A gaming system as claimed in claim 1, comprising an outcome evaluator arranged to determine whether a winning outcome exists on the basis of the game portions and game panels selected by the selector.

17. A gaming system as claimed in claim 1, wherein the gaming system is arranged such that selection of a game portion effects selection of an identifier associated with the game portion to form part of a game outcome, and selection of at least one game panel signifies how many identifiers are considered to be part of the game outcome.

18. A gaming system as claimed in claim 1, wherein the gaming system is arranged such that a winning outcome is determined by comparing an outcome combination including a game portion and at least one associated game panel with a pay table.

19. A gaming system as claimed in claim 1, wherein one or more of the selector and the outcome evaluator is constituted, at least in part, by a processor executing program code stored in a memory.

20. A gaming system as claimed in claim 1, wherein the gaming system comprises a game play mechanism operable to place a wager and the outcome evaluator evaluates the outcome based on the wager and based on the game portions and game panels selected by the selector.

21. A method of gaming, the method comprising:
providing a plurality of game portions;
providing a plurality of game panels, each game portion being associated with at least one game panel;
selecting at least one game portion and at least one game panel;
communicating to a player the selected at least one game portion and the selected at least one game panel;
determining a winning game outcome by evaluating a combination of at least one selected game portion and at least one game panel associated with the at least one selected game portion.

22. A method as claimed in claim 21, comprising providing physical game portions and game panels.

23. A method as claimed in claim 22, comprising providing a plurality of light devices, each light device being associated with one of the game portions and game panels, and controlling the light devices so as to illuminate the selected game portions and game panels.

24. A method as claimed in claim 21, comprising representing the game portions and the game panels graphically on a video display.

25. A method as claimed in claim 21, comprising associating each game portion with an identifier.

26. A method as claimed in claim 25, wherein the identifier comprises a symbol, number, icon or picture.

27. A method as claimed in claim 25, wherein the identifier is in the form of a particular colour.

28. A method as claimed in claim 21, comprising emphasizing selected game portions and selected game panels relative to game portions and game panels which have not been selected.

29. A method as claimed in claim 28, comprising illuminating the selected game portions and/or game panels with an intensity greater than game portions and game panels which have not been selected.

30. A method as claimed in claim 28, comprising illuminating the selected game portions and/or game panels with a different colour than game portions and game panels which have not been selected.

31. A method as claimed in claim 28, comprising causing the selected game portions and/or game panels to flash.

32. A method as claimed in claim 21, wherein the game portions and the game panels together define a disk-like configuration having an inner disk and an annular portion surrounding the inner disk, the game portions are segments of the inner disk, and the game panels are disposed in the annular portion.

33. A method as claimed in claim 21, comprising providing more game panels than game portions.

34. A method as claimed in claim 33, wherein each game portion is associated with 5 game panels.

35. A method as claimed in claim 21, wherein the method is arranged such that selection of a game portion effects selection of an identifier associated with the game portion to form part of a game outcome, and selection of at least one game panel signifies how many identifiers are in the game outcome.

36. A method as claimed in claim 21, comprising determining a winning outcome by comparing an outcome combination including a game portion and at least one associated game panel with a pay table.

37. A method as claimed in claim 21, wherein one or more of the selector and the outcome evaluator is constituted, at least in part, by a processor executing program code stored in a memory.

38. A method as claimed in claim 21, wherein the method comprises providing a game play mechanism operable to place a wager, and evaluating the outcome based on the wager and based on the selected game portions and game panels.

39. A computer readable medium having computer readable program code embodied therein, the computer readable program code being arranged when loaded into a computer to cause the computer to operate in accordance with a gaming system comprising:
a plurality of game portions;
a plurality of game panels, each game portion being associated with at least one game panel; and
a selector arranged to select at least one game portion and at least one game panel;
the gaming system being arranged to communicate to a player the selected at least one game portion and the selected at least one game panel;
wherein a winning game outcome is determined by a combination of at least one selected game portion and at least one game panel associated with the at least one selected game portion.
